(19) United States
(12) Patent Application Publication
(10) Pub. No.: US 2007/0238346 A1
(43) Pub. Date: Oct. 11, 2007

(54) Edge connector with step groove

(75) Inventor: Yi-Tse Ho, Tainan Hsien (TW)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/726,322

(22) Filed: Mar. 21, 2007

(30) Foreign Application Priority Data
Mar. 21, 2006 (TW) 95204713

(51) Int. Cl. H01R 13/62

(52) U.S. Cl. 439/326

(57) ABSTRACT

A card edge connector that allows the insertion of an electric card includes an insulating body and a plurality of terminals. The insulating body has a body portion and two side frames. The body portion has an insertion slot. The lower portion of the front end of the body portion has a stepped trough. The terminals are mounted onto the body portion via fixing portions, and are distributed on upper and lower sides of the insertion slot. The terminals on the lower side are mounted onto the body portion via the stepped trough, thereby reducing the length that the pin portion of the terminal on the lower side protrudes from the front end of the body portion. The present invention utilizes the stepped trough to reduce the length that the pin portion protrudes from the front end of the body portion of the insulating portion. When the electric card is inserted, the electric card is prevented from contacting the pin portion.

### FIELD OF THE INVENTION

The present invention relates to a card edge connector, and in particular to a card edge connector provided on the upper surface of a circuit board that allows an electric card to be inserted therein but prevents the electric card from contacting a pin portion of a terminal.

### BACKGROUND OF THE INVENTION

A conventional card edge connector is provided on the upper surface of a circuit board and allows an electric card to be inserted therein, thereby electrically connecting the circuit board and the electric card. Taiwan Patent Publication No. 415662 (Application No. 88203661) published on Dec. 11, 2000 discloses an electric connector comprising an insulating body provided with a central insertion slot for accommodating a memory module (i.e., an electric card), a plurality of terminals distributed on both sides of the central insertion slot, and a pair of locking devices provided on two opposite ends of the insulating body. Each locking device includes plastic pieces and metallic pieces, wherein the plastic pieces comprise a locking portion and a connecting means usually provided under the locking portion. The connecting means is used for connecting the plastic piece with the metallic piece.

In the above-mentioned conventional card edge connector, a plurality of terminals is distributed on the upper and lower sides of the central insertion slot. The terminals on the lower side are mounted in a terminal trough of the insulating body. The pin portion of the terminal protrudes from the front end of the insulating body by a larger length/due to their length being greater than that of the terminal. Therefore, when the electric card has been inserted, the electric card is prone to contact the pin portion of the terminal, causing a short circuit to occur or damage to be caused to the terminals. In order to prevent the electric card from contacting the pin portion of the terminal, a common solution is to restrict the shape of the electric card so as to avoid it contacting the pin portion of the terminal. However, in such a situation, the space applicability of the electric card will be limited and thus the utilization ratio is small. Therefore, in view of this, the inventor proposes the present invention to overcome the above problems.

### SUMMARY OF THE INVENTION

The primary object of the present invention is to provide a card edge connector that prevents the electric card from contacting the pin portion of the terminal and avoids a short circuit from occurring and prevents damage from being caused to the terminals. Therefore, the space applicability of the electric card will not be limited and the utilization ratio is larger.

In order to achieve the above object, the present invention provides a card edge connector comprising an insulating body and a plurality of terminals. The insulating body has a body portion and two side frames extending from both ends of the body portion. The body portion is provided with an insertion slot. The lower portion of the front end of the body portion is formed with a stepped trough. Each terminal has a contacting portion, a pin portion, and a fixing portion. The terminals are mounted onto the body portion of the insulating body via the fixing portions, and distributed on the upper and lower sides of the insertion slot. The terminals on the lower side are mounted onto the body portion via the stepped trough, thereby reducing the length of the pin portion of the terminal on the lower side that protrudes from the front end of the body portion.

The advantage of the present invention lies in that in the insulating body of the card edge connector the lower portion of the front end of the body portion is provided with a stepped trough. The stepped trough is recessed into the front end of the body portion so that the front end of the body portion is formed into a stepped portion. The terminals are mounted into the terminal troughs of the insulating body via the stepped trough thereby reducing the length of the pin portion of the terminal that protrudes from the front end of the body portion. When the electric card is inserted the electric card is prevented from contacting the pin portion of the terminal. Therefore it is unnecessary to limit the shape of the electric card, the space applicability of the electric card is not limited and the utilization ratio is larger.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is an exploded perspective view of the card edge connector of the present invention, a circuit board and an electric card;

FIG. 2 is an assembled perspective view of the card edge connector of the present invention, a circuit board and an electric card;

FIG. 3 is a top view of the card edge connector of the present invention, a circuit board and an electric card;

FIG. 4 is a cross-sectional view taken along the line 4-4 in FIG. 3;

FIG. 5 is a cross-sectional view taken along the line 5-5 in FIG. 3;

FIG. 6 is a perspective view of the card edge connector of the present invention taken from another view angle; and

FIG. 7 is a view showing the details of a portion of the card edge connector of the present invention.

### DETAILED DESCRIPTION OF THE INVENTION

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

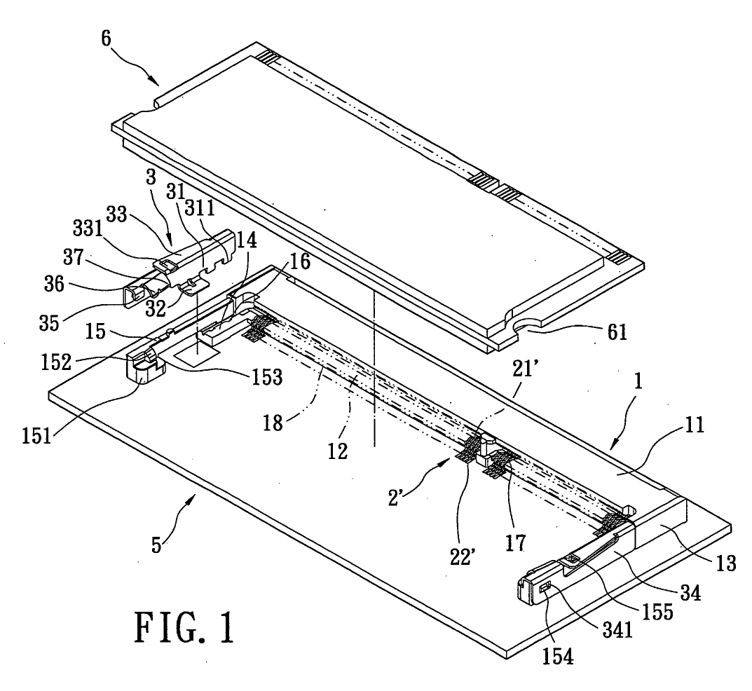

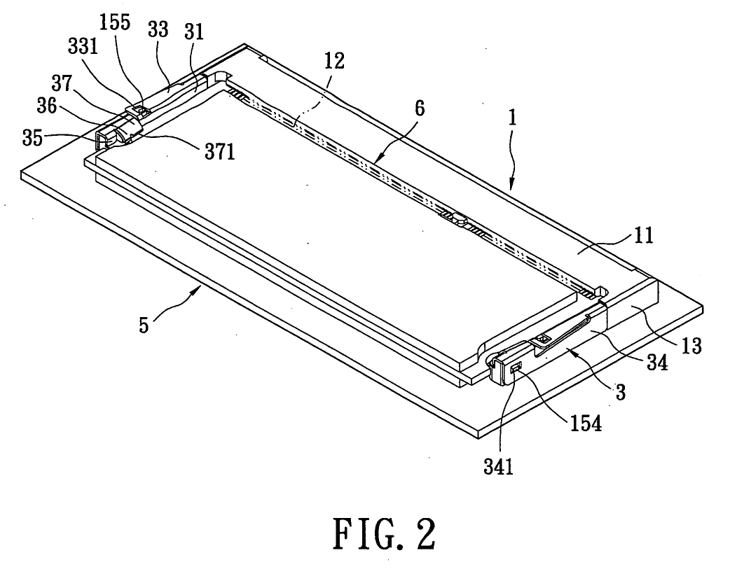

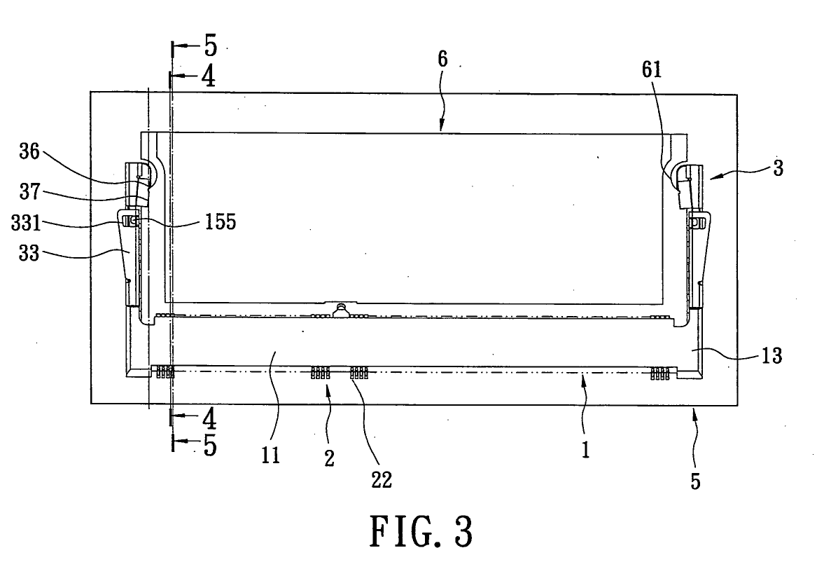

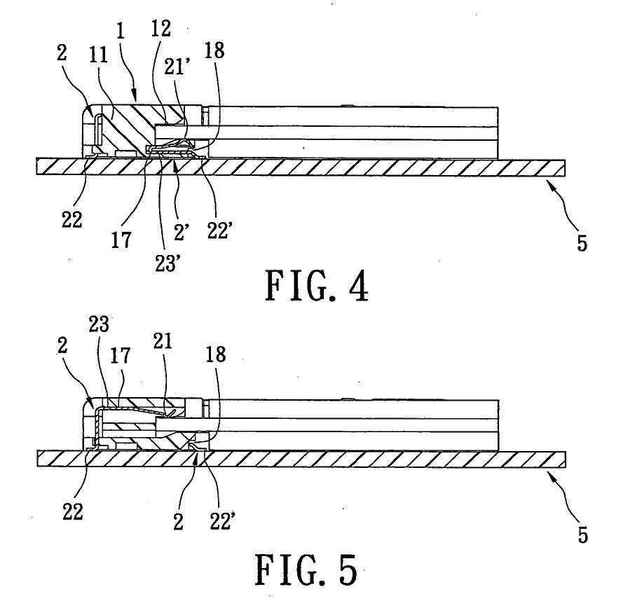

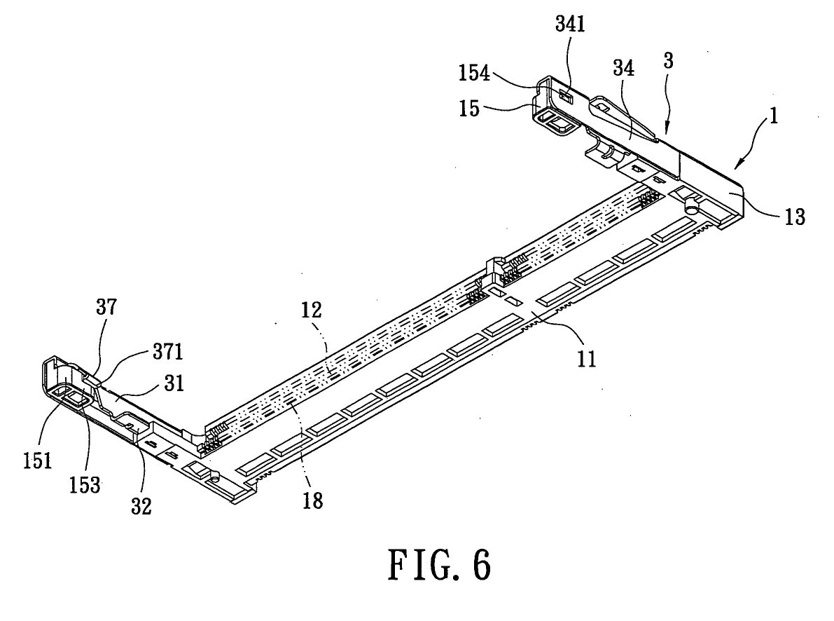

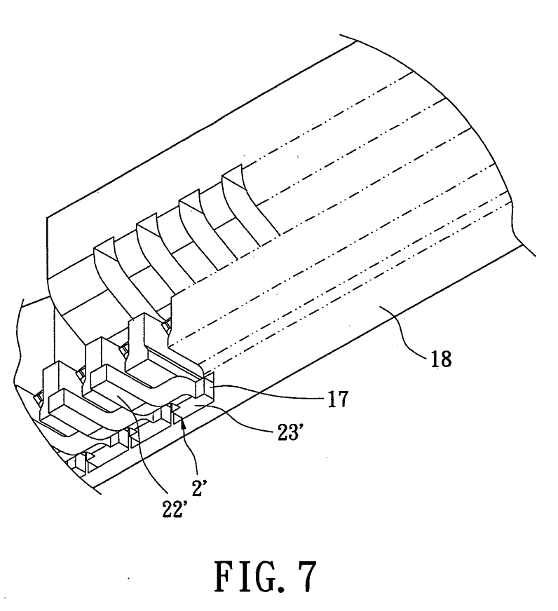

Please refer to FIGS. 1 to 7 in which the present invention of a card edge connector is shown. The card edge connector is provided on an upper surface of a circuit board 5 and allows the insertion of an electric card 6 thereby electrically connecting the circuit board 5 and the electric card 6. The card edge connector comprises an insulating body 1, a plurality of terminals 2, 2′, and two metallic pieces 3. The insulating body 1 is made of plastic material and has a body portion 11. The body portion 11 is provided thereon with an insertion slot 12 that allows the insertion of the electric card 6. An elongated side frame 13 extends from each end of the body portion 11. The inside of each side frame 13 is provided with a platform 14 along the extending direction for disposing the electric card 6 thereon. The body portion 11 is provided with a plurality of terminal troughs 17. The terminal troughs 17 are arranged in two rows and in communication with the insertion slot 12. The lower portion of the front end of the body portion 11 is further provided with a stepped trough 18. The stepped trough 18 is recessed into the lower portion of the front end of the body portion 11 so that the front end of the body portion 11 is formed into a stepped portion.

Each of the free ends of the two side frames 13 extends to form an elastic hooking arm 15. The inside of the each elastic hooking arm 15 is provided with a positioning block 151 and a projecting block 152. The positioning block 151 is formed into a lump body and is used to lock the corresponding notches 61 of both sides of the electric card 6 so that the electric card 6 cannot move forwards or backwards. The insides of the two elastic hooking arms 15 each have a stopping platform 153 adjacent to the positioning block 151. The stopping platform 153 is adjacent to the rear edge of the positioning block 151 and is used to stop the lower surface of the electric card 6.

The terminals 2, 2′ are provided in the insertion slot 12 of the body portion 11 of the insulating body 1. Each of the terminals 2, 2′ has a contacting portion 21, 21′, a pin portion 22, 22′, and a fixing portion 23, 23′. The contacting portion 21, 21′ and the pin portion 22, 22′ are connected to both ends of the fixing portion 23, 23′, respectively. The terminals 2, 2′ are mounted into the terminal troughs 17 via the fixing portion 23, 23′. The terminals 2, 2′ are distributed on the upper and lower sides of the insertion slot 12. The contacting portion 21, 21′ is used for electrically contacting the electrical contacts of the electric card 6. The pin portion 22, 22′ extend beyond the body portion 11 for electrically connecting with the electrical contacts of the circuit board 5. Since the front end of the body portion 11 of the insulating body 1 is provided with a stepped trough 18, when the terminals 2′ on the lower side are mounted into the terminal trough 17 of the insulating body 1, the distance that the pin portion 22′ of the terminal 2′ protrudes from the front end of the body portion 11 of the insulating body 1 can be reduced.

The two metallic pieces 3 are made of metallic material by means of pressing. The two metallic pieces 3 are mounted on the two elastic hooking arms 15. Each of the two metallic pieces 3 has a substrate 31, a welded portion 32, a top plate 33, an elastic arm 34, a turning portion 35, a covering portion 36, and a pressing portion 37. The substrate 31 is an upright plate and provided inside the elastic hooking arm 15. The lower edge of the substrate 31 extends downwardly to form an insertion piece 311 that is fixedly inserted into a corresponding insertion hole 16 of the insulating body 1, thereby mounting the two metallic pieces 3 on the insulating body 1 stably.

The welded portion 32 extends horizontally and inwardly from the lower edge of the substrate 31. The welded portion 32 can be welded and fixed on the circuit bard 5 to electrically connect the metallic piece 3 with the circuit board 5, thereby grounding the electric card 6. The top plate 33 is formed by extending the upper edge of the substrate 31 horizontally and outwardly. The top plate 33 is provided with a constraining hole 331. The constraining hole 331 is located on the top plate 33 and is adjacent to the free end of the elastic hooking arm 15. Further, the top surface of the elastic hooking arm 15 is provided with a constraining block 155 that is projected into the constraining hole 331. The width of the constraining hole 331 is greater than that of the constraining block 155 so the constraining block 155 can transversely move in the constraining hole 331.

The elastic arm 34 extends downwardly and forwardly from the outer edge of the top plate 33 and is positioned near the rear end thereof. The front end of the elastic arm 34 is formed into a free end and is provided on the outside of the elastic hooking arm 15. The elastic arm 34 is provided thereon with a locking hole 341. The locking hole 341 is located on the elastic arm 34 and is adjacent to the free end thereof. The outside of the elastic hooking arm 15 is provided with a locking block 154 that corresponds to the locking hole 341. The locking hole 341 and the locking block 154 are locked into each other.

The turning portion 35, the covering portion 36, and the pressing portion 37 extend inwardly and downwardly from the free end of the elastic arm 34. The turning portion 35 turns the elastic arm 34 and the elastic hooking arm 15 outwardly, so that the positioning blocks 151 can be detached from the notches 61 of both sides of the electric card 6, thereby smoothly ejecting the electric card 6. The upper edges of the covering portion 36 and the pressing portion 37 are formed into curved surfaces and guide the electric card 6 to be pressed into position. The covering portion 36 covers the outside of the projecting block 152 of the elastic hooking arm 15, thereby reinforcing the strength of the metallic piece 3. The bottom surface of the pressing portion 37 is formed with a pressing surface 371 for pressing the upper surface of the electric card 6. The pressing surface 371 is located above the stopping platform 153 with a suitable gap therebetween. With/Via the above structure, the card edge connector of the present invention is obtained/is formed.

The card edge connector can be provided on the circuit board 5 and allows the insertion of the electric card 6 into the insulating body 1 so that the electrical contacts of the electric card 6 can be electrically connected with the circuit board 5 via the terminals 2 within the insertion slot 12. When the electric card 6 is inserted into the insulating body 1, the positioning blocks 151 of the two elastic hooking arms 15 lock the notches 61 of the electric card 6 inwardly, thereby preventing the electric card 6 becoming detached from the insertion slot 12. The pressing surfaces 371 of the pressing portions 37 of the two metallic pieces 3 abut against the upper surface of the electric card 6, thereby stabilizing the insertion of the electric card 6 and grounding (the device???). The stopping platforms 153 of the two elastic hooking arms 15 stop the lower surface of the electric card 6, thereby supporting the electric card 6 on the insulating body 1 firmly. When the electric card 6 is to be removed, the turning portion 35 turns the elastic arm 34 to move outwardly. The elastic arm 15 also moves outwardly along with the elastic arm so that the positioning blocks 151 are detached from the notches 61 of both sides of the electric card 6. As a result, the pressing portions 37 of the two metallic pieces 3 are detached from the upper surface of the electric card 6, thereby allowing the electric card 6 to be removed easily.

Since the top plates 33 of the two metallic pieces 3 are each provided with a constraining hole 331, and the top surfaces of the two elastic hooking arms 15 are each provided with a constraining block 155 that is projected into the constraining hole 331, the constraining block 155 will abut against the outer edge of the constraining hole 331 to constrain the position thereof when the elastic arm 34 and the elastic hooking arm 15 are turned outwardly to an excessive extent. Such a design prevents the elastic arm 34 and the elastic hooking arm 15 from turning outwardly to an excessive extent and thus avoids any possible permanent deformation or breakage.

The advantage of present invention lies in that the front end of the body portion 11 of the insulating body 1 is provided with a stepped trough 18. The stepped trough 18 is recessed into the lower portion of the front end of the body portion 11 so that the front end of the body portion 11 forms into a stepped portion. As a result, when the terminals 2′ on the lower side are mounted into the terminal trough 17 of the insulating body 1, the length that the pin portion 22′ of the terminal 2′ protrudes from the front end of the body portion 11 of the insulating body 1 can be reduced. Therefore, when the electric card 6 is inserted, the electric card 6 is prevented from contacting the pin portion 22′ of the terminal 2′ and avoids short circuits or damage to the terminals from occurring. It is unnecessary to limit the shape of the electric card 6. Therefore, the space applicability of the electric card will not be limited and the utilization ratio is larger.

While a preferred embodiment of the invention is shown and described, it is envisioned that those skilled in the art may devise various modifications without departing from the spirit and scope of the foregoing description and the appended claims.

What is claimed is:

1. A card edge connector, comprising:
an insulating body having a body portion and two side frames extending from both ends of the body portion, the body portion being provided with an insertion slot, the lower portion of the front end of the body portion being formed with a stepped trough; and
a plurality of terminals each having a contacting portion, a pin portion, and a fixing portion, the terminals being mounted in the body portion via the fixing portions and distributed on upper and lower sides of the insertion slot, the terminals on the lower side being mounted onto the body portion via the stepped trough, thereby reducing the length that the pin portion of the terminal on the lower side protrudes from the front end of the body portion.

2. The card edge connector according to claim 1, wherein the body portion of the insulating body is provided with a plurality of terminal troughs, the terminal troughs are arranged in two rows and in communication with the insertion slot, the terminals are mounted in the terminal troughs.

3. The card edge connector according to claim 1, wherein each of the free ends of the two side frames extends to form an elastic hooking arm, each inside of the two elastic hooking arms is provided with a positioning block, and a metallic piece is mounted on each of the two elastic hooking arms.

4. The card edge connector according to claim 3, wherein each inside of the two elastic hooking arms is provided with a projecting block, each of the two metallic pieces has a covering portion, and the covering portion covers the outside of the projecting block of the elastic hooking arm.

5. The card edge connector according to claim 3, wherein each of the two metallic pieces has a substrate, a top plate, an elastic arm, and a pressing portion, the substrate is provided at the inside of the elastic hooking arm, the top plate is formed by means of extending outwardly from the upper edge of the substrate, the elastic arm is formed by means of extending from the outer edge of the top plate at a position near the rear end thereof, the front end of the elastic arm is formed into a free end, the elastic arm is provided at the outside of the elastic hooking arm, the pressing portion is formed by means of extending from the free end of the elastic arm, and the bottom surface of the pressing portion is formed with a pressing surface.

6. The card edge connector according to claim 5, wherein each of the two metallic pieces has a turning portion, and the turning portion is formed by means of extending from the free end of the elastic arm.

7. The card edge connector according to claim 5, wherein each of the two metallic pieces has a welded portion, and the welded portion is formed by means of extending from the lower edge of the substrate.

8. The card edge connector according to claim 5, wherein the lower edge of the substrate extends downwardly to form an insertion piece, and the insertion piece is inserted and fixed into a corresponding insertion hole of the insulating body.

9. The card edge connector according to claim 5, wherein the elastic arm is provided with a locking hole thereon, the locking hole is located on the elastic arm and adjacent to the free end thereof, the outside of the elastic hooking arm is provided with a locking block corresponding to the locking hole, the locking hole and the locking block are locked to each other.

10. The card edge connector according to claim 1, wherein the card edge connector allows an electric card to be inserted therein.

11. The card edge connector according to claim 10, wherein each of the free ends of the two side frames extends to form an elastic hooking arm, the inside of the two elastic hooking arms are each provided with a positioning block, and the positioning blocks of the two elastic hooking arms lock onto the notches of both sides of the electric card.

12. The card edge connector according to claim 11, wherein a metallic piece is mounted to each of the two elastic hooking arms, each of the two metallic pieces has a pressing portion, the bottom surface of the pressing portion is formed with a pressing surface, and the pressing surface presses on the upper surface of the electric card.
